(19) United States
(12) Patent Application Publication
(10) Pub. No.: US 2018/0125284 A1
(43) Pub. Date: May 10, 2018

(54) Kettle

(71) Applicant: Piers St John Spencer CAVE, Knapjill, Woking (GB)

(72) Inventor: Piers St John Spencer CAVE, Knapjill, Woking (GB)

(21) Appl. No.: 14/903,021

(22) PCT Filed: Jul. 7, 2014
(86) PCT No.: PCT/GB2014/000273

§ 371 Date: Apr. 25, 2016

(30) Foreign Application Priority Data
Jul. 5, 2013 (GB) 13112120.7

(51) Int. Cl. A47J 27/21

(52) U.S. Cl. CPC A47J 27/21166; A47J 27/21058; A47J 27/21016

(57) ABSTRACT

The present invention provides a kettle that has a plurally of chambers and which is configured to boil water in one chamber and condense the steam therefrom in another chamber or other part of the kettle. The kettle may have a heating element in one of the chambers that raises the temperature of the water in that chamber to boiling point and the heating of the water is carried out in stages, each stage elevating the temperature farther and being carried out in a successive one of the chambers. The kettle allows water to be boiled far more efficiently than in conventional kettles and can have a significant impact not only in reducing house-hold carbon footprint but also in reducing demand spikes in electricity usage.

### CROSS REFERENCE TO RELATED APPLICATIONS

This application is a national stage entry of PCT/GB2014/000273 filed on Jul. 7, 2014, which claims the benefit of Great Britain patent application no. 13112120.7 filed on Jul. 5, 2013.

### BACKGROUND OF THE INVENTION

### Field of the Invention

The present invention concerns improvements in and relating to kettles—and primarily to kettles of the type as used, for example, in domestic kitchens for heating about one to four litres of water substantially to boiling point for hot beverages or use in cooking or any other purpose.

### BACKGROUND OF THE INVENTION

Domestic kettles, also referred to as water kettles, have evolved into a wide array of shapes and forms over recent years but all basically have a portable container body that may be picked up by a handle and tilted to pour out the heated water content with a top opening and spout for owing and having a heating element in the base of the container. Technologically the commercially available kettles have not advanced greatly. The main advances have been limited to use of better insulating materials and heat conductive plates rather than coils, and use of electrical powering base stations either with pin-in-socket direct electrical coupling or using induction.

It is widely known that the boiling of kettles is a significant component of household energy usage/carbon footprint. A much-quoted example of massive surges in demand on our UK national grid are the surges that occur at the half-time interval of major international football matches et cetera when the TV viewing public all rise from their sofa at the same time to boil their electrical kettle for a cup of tea. The corresponding governmental advice for energy saving is for each of us to boil only such volume of water as is required and to be more frugal in using the kettle.

Energy efficiency of commercially available kettles, despite the clear need for improvement, still has not improved greatly over the years and kettle usage represents a significant element of our carbon footprint. The average kettle uses about 0.11 KWh to boil 1 litre of water and on average a kettle in the UK is used 1,500 times in a year to boil water, equating to a carbon footprint of about 73 kg carbon dioxide per kettle per year. Bearing in mind that about 7.5 million kettles are sold in the UK each year there are about 4,950 GWh used in boiling kettles in the UK alone each year and equating to total carbon dioxide emissions of 2.2 million tonnes or more. We need to do much better.

Proposals have been made in recent years for hot water boilers that recover steam given off when boiling water. In Japanese patent application JP2010172557 (Mitsubishi) a boiling station recovers steam as water externally in a separate condensing vessel outside the boiling station. The system is not a kettle but an installed system and it consumes electrical energy not just for heating the water but also for pumping the water. In other prior art, PCT application WO2004/073466 (Renton), kettles have been proposed that direct a substantial part of the steam in the top of the kettle to pass cooling surfaces/fins in the kettle lid or spout wall to help to condense the steam to water before it is drained back to the boiling chamber or discharged through the spout and thereby substantially prevent risk of scalding. In this arrangement some of the energy from the steam is recovered as a small volume of heated water but a large part of the energy of the steam is dissipated externally by the cooling fins and construction of the kettle. GB2480360 (Otter Controls) has an anti-spill mechanism that operates to re-direct water and steam away from the lid and spout if the kettle is inadvertently tipped and can again return a small volume of steam condensed water to the kettle's boiling chamber, but overall adds very little to energy efficiency of the kettle.

In summary, kettles use a substantial amount of energy and are virtually unique with the power demand spikes that they create in an electrical power supply system, network/grid. Renewable energy cannot easily deal with spikes in demand. Existing kettle designs cope poorly in addressing the energy efficiency problem and none of the existing kettles address the problem of spikes in demand.

It is an object of the present invention to provide do improved kettle that addresses the energy efficiency problems of the prior art, enabling a given volume of water to be heated in a kettle with substantially lower energy inputs than in the prior kettles.

### SUMMARY OF THE INVENTION

According to first aspect of the present invention there is provided a kettle that has a portable container body that may be picked up by a handle and tilted to pour out the heated liquid content with a top opening and spout for pouring, wherein the container has a plurality of chambers comprising: at least a boiling chamber having a heating element to boil liquid therewithin and connected to at or near the spout for pouring the liquid from the boiling chamber out of the kettle; and a pre-heat chamber for pre-heating the liquid prior to the boiling chamber, the kettle having a heat transfer feature to transfer thermal energy from the boiling chamber to the pre-heat chamber thereby recovering thermal energy from the boiling chamber for pre-heating the liquid that would otherwise go to waste.

A heat transfer feature for transferring thermal energy from the boiling chamber to the pre-heat chamber in one aspect preferably comprises a conduit for steam, condensate (and/or less preferably heated liquid) from the boiling chamber to the pre-heating chamber.

Particularly preferably the pre-heat chamber is thermally insulated and substantially shielded from direct heat transfer relationship with the boiling chamber at least during boiling in the boiling chamber. A thermal barrier is positioned between the pre-heat chamber and the boiling chamber. This barrier mitigates against thermal drag on the boiling chamber by the pre-heat chamber so that the liquid in the boiling chamber heats up quickly and efficiently.

Preferably there is a flow control barrier between the pre-heat chamber of the kettle and the boiling chamber whereby liquid in the pre-heat chamber of the kettle is allowed to flow to the boiling chamber prior to the boiling phase of heating. Preferably the barrier is locked shut but opens when the kettle is to be or being filled or poured. The barrier may be manually controlled to open but particularly preferably is opened automatically.

In addition to or in alternative to the steam/condensate conduit, the heat transfer feature for transferring thermal energy from the boiling chamber to the pre-heat chamber particularly preferably comprises a heat conductive material thermal shunt and which preferably is in a wall between the boiling chamber and the pre-heat chamber and which selectively operates to thermally bypass the thermal barrier between the pre-heat chamber and the boiling chamber. The heat conductive material thermal shunt is preferably a thermally conductive material that is configured to selectively be moved into and out of a position that thermally bridges to the pre-heat chamber. The thermal barrier is preferably a vacuum flask/vacuum chamber and the thermal shunt is preferably located within this and able to move into and out of position within it. Suitably the thermal shunt is on a rotary spindle arid rotates into and out of position. The vacuum flask/chamber preferably is formed with a thermally conductive outer wall such as of aluminium so that when the shunt is in position it can transfer energy to and across the wall of the vacuum flask/chamber.

Particularly preferably the heat conductive material thermal shunt is automated or controlled by a controller (eg programmed or responsive device such as a micro-controller) to flip/switch from an inoperative state where it does not bridge to the pre-heat chamber to an operative state where it does bridge to the pre-heat chamber. Preferably it is automated or controlled to switch to the operative state once the liquid in the kettle boiling chamber has been poured out.

The heating of the liquid loaded into the kettle is carried out in stages, each stage elevating the temperature of the liquid farther and being in a successive one of the chambers. The liquid, eg water, is pre-heated in the pre-heat chamber by residual/waste thermal energy from the boiling chamber. A second pre-heat chamber is preferably further provided. Preferably a first one of the pre-heat chambers initially raises the temperature of liquid introduced into the kettle and the thus initially pre-heated liquid then passes to the second pre-heat chamber which elevates the liquid's temperature further prior to it being transferred to the boiling chamber. The second pre-heat chamber preferably uses direct conduction heat transfer of residual heat from the boiling chamber/boiling plate while the first pre-heat chamber preferably uses direct conduction heat transfer of residual heat from the boiling chamber sidewalls and/or heat from steam from the boiling chamber.

The kettle has an aperture or conduit from the first chamber to the second chamber. Preferably the first pre-heat chamber is an upper chamber and the second pre-heat chamber is a lower chamber, below the first pre-heat chamber.

Suitably at least one of the chambers (primarily the first/upper pre-heat chamber) of the kettle is open to the atmosphere and the kettle is configured'to allow the liquid to flow by gravity from upper to lower chamber and with the liquid in the kettle settling to its level in the inter-connected chambers by gravity and under atmospheric pressure. The kettle may have a heating element in the second pre-heating chamber to raise the temperature of the water or other liquid placed therein towards its boiling point but preferably the heating there is by thermal energy recovered from the boiling chamber. A steam/vapour conduit is preferably provided from the boiling chamber to feed the steam/vapour to an adjoining chamber. The chamber to which the steam/vapour is fed is particularly preferably the first pre-heating chamber. The steam/vapour from the conduit may be emitted directly into the first pre-heating chamber to admix with water/liquid for an initial pre heating of the water/liquid in the first pre-heating chamber or else passes through a heat exchange arrangement (eg a heat exchange coil) to indirectly heat the water/liquid in the first chamber.

Preferably the kettle has a casing housing the three chambers and which is adapted to provide good insulation. The insulation of the casing may comprise a cellular or foam lining. Preferably there is an air gap between the casing and the chambers. Furthermore, the casing may have a heat reflective interior to reduce loss of heat. The walls of the pre-heating chambers and especially those that surround the boiling chamber are preferably formed as vacuum flask/vacuum chamber walls, suitably of aluminium with a partial vacuum within.

The heating elements of the kettle may be directly powered resistance heating elements/coils or may be inductively powered heating elements, the kettle being an electric powered kettle. For greater control of operation beyond simply having a power-on switch for energising the heating element(s) and a thermostatic regulator to cut off power when the boiling point is reached, the kettle may further include one or more valves/controlled closure means to shut the apertures/conduits between the chambers. The kettle is preferably configured to close the passages between adjoining chambers, isolating them from each other when the kettle is switched on to allow dwell time for the liquid in the respective chambers to be heated sufficiently before passing to the next chamber. Also, in particularly preferred embodiments of the invention flow between the boiling chamber and the pre-heating chamber feeding into it may be blocked by the afore-mentioned flow control harder to prevent any back-flow or other disruption to the boiling phase.

The kettle may have selector witch means that enable selection between heating a high volume of liquid in the kettle that is greater than the volume in just one chamber or heating a single chamber volume, ie which selects between power up of heating means in just one of the chambers or power up of heating means in two or more of the chambers.

In the most preferred embodiments a pre-heat chamber surrounds the boiling chamber as an annulus. Preferably that is the first pre-heat chamber and preferably the second pre-heat chamber fully covers the boiling chamber from below. The boiling chamber is thus fully surrounded. Preferably the first pre-heating chamber adjoins a sidewall of the boiling chamber and has a thermal barrier wall between it and the boiling chamber that has a selectively operable thermal shunt, whereby residual heat from the boiling chamber sidewall may be conductively transferred to that pre-heating chamber.

In an important further aspect of the invention the kettle has a processor or controller that is programmed to control the kettle to manage operation of the kettle's use of energy. The processor or controller is preferably programmed with one or more predictive algorithms to predict and thence control the kettle to manage operation of the kettle's use of energy and minimise demand spikes or enable the kettle to be pre-heated or boiled for predicted demand. Preferably the processor or controller is programmed to control the kettle to manage operation of the kettle's use of energy to be pre-heated when surplus electrical energy is available.

In a variant of the invention preferably the pre-heat chamber is not in fluid communication with the boiling chamber but is selectively in conductive heat transfer with the boiling chamber via a thermal shunt for conductive heat transfer heating of the liquid in the boiling chamber.

### BRIEF DESCRIPTION OF THE DRAWINGS

Preferred embodiments of the invention will now be more particularly described, solely by way of example, with reference to the accompanying drawings in which:

FIG. 1 is a schematic transverse sectional diagram of a first preferred embodiment of kettle of the present invention, showing the insulative casing housing three heating chambers.

FIG. 2 is a schematic transverse sectional diagram of a second preferred embodiment of kettle of the present invention, showing a modified form of the third heating chamber and a modified steam conduit arrangement.

FIG. 3 is a schematic transverse sectional diagram of a third preferred embodiment of kettle of the present invention, with further enhanced heat management including a heat transfer barrier between the pre-heat chambers and boiling chamber and a switchable thermal shunt for selective transfer of heat from the boiling chamber/heating element of the boiling chamber and with the boiling chamber surrounded laterally and from below by the pre-heat chambers.

FIGS. 4A and 4B each show schematically the switchable thermal shunt in the thermal barrier wall between the pre-heat chambers and the boiling chamber, with FIG. 4A being in the inoperative state and FIG. 4B being in the operative state for transferring heat across the barrier wall.

### DESCRIPTION OF THE ILLUSTRATED EMBODIMENTS

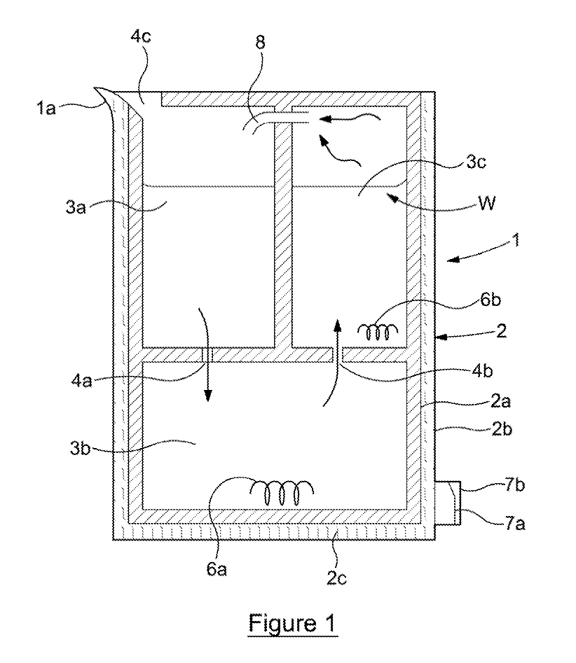

Referring firstly to FIG. 1, the illustrated embodiment of the kettle 1 has the substantially conventional external kettle form of a three litre jug with a pouring spout 1a.

The kettle has an outer casing 2 that suitably is circular cylindrical and which may be moulded of plastics or other suitable material and the illustrated example having a double skin concentric cylindrical wall 2a, 2b with the cavity between the skins 2a, 2b of the wail being filled with foam or fibrous insulation material 2e.

Housed within the central void of the casing 1 are a set of three water-holding chambers 3a, 3b, 3c, each formed as a substantially water-tight vessel with openings 4a, 4b, 8 for fluid communication between them and at least a first of the chambers 3a having an opening 4e to atmosphere and serving to normalise pressure with atmospheric as well as serving as a filling aperture and/or for delivery of the boiled water via the spout 1a. Unlike the first chamber 3a, the other two chambers 3b, 3c are substantially enclosed so that as the water is heated, the heated water and the steam is contained yet is able to flow to the first chamber 3a to be poured from the kettle 1 when ready. The three chambers 3a, 3b, 3c may integrally formed by partitions in a single moulding, as illustrated, or be initially separate vessels that are assembled together within the casing in use.

The three chambers 3a, 3b, 3c of the illustrated embodiment have first chamber 3a of the same or similar volume capacity to the other two chambers 3b, 3c and each may suitably hold, say, 1 litre apiece for 3 litres overall kettle capacity. The first chamber and third chamber 3c both stand over the second lower chamber 3b and when water is fed into the first chamber 3a it flows under gravity firstly down through aperture/conduit 4a into the second, lower chamber 3b filling that chamber and then rises up through aperture/conduit 4b into the upper, third chamber 3c until the levels W in the first chamber 3a and third chamber 3b equilibrate. Once the kettle 1 is filled with the required volume of tap-water a lid (not shown) may be closed over most or all of the filling inlet/delivery outlet opening in the top of the first chamber 3a but suitably leaving sufficient communication with atmospheric to prevent any serious pressure build-up.

The first chamber 3a is a first pre-heating chamber for pre-heating the water before it is boiled. The second chamber 3b is a second pre-heating chamber for heating the water further prior to boiling. The third chamber 3c is a boiling chamber where the water is finally heated to boiling point before being pored out.

As shown in FIG. 1 the kettle has a first electrical heating element 6a in the floor of the lower, second chamber 3b and also has a second electrical heating element 6b in the floor of the upper, third chamber 3b. A selector switch 7b is provided on the exterior of the kettle 1 to choose between energising just the first electrical heating element 6a or both electrical heating elements 6a, 6b.

Next the user may turn the kettle on at the power button 7a provided at the base of the kettle and at the same time selecting at selector switch 7b for both heating elements 6a, 6b to be energised where it is desired not only to electrically heat the volume in the second chamber 3b but also the volume in the third chamber 3c.

The kettle 1 may operate to close off one or both of the apertures/conduits 4a, 4b to contain the water in the respective chambers 3a, 3b, 3c while electrically heating the water. If the water in second chamber 3b is heated then any steam generated may flow through a steam conduit 8 between the third chamber 3c and first chamber 3a for the steam to be fed into the first chamber 3a that lacks electrical heating and thus the steam may give up its heat as it condenses in first chamber 3a—either mixing straight into any water in that chamber 3a or being held separate in a heat exchanger coil in the first chamber 3a so as to pass its heat through the walls of the coil into the surrounding water in the first chamber 3a.

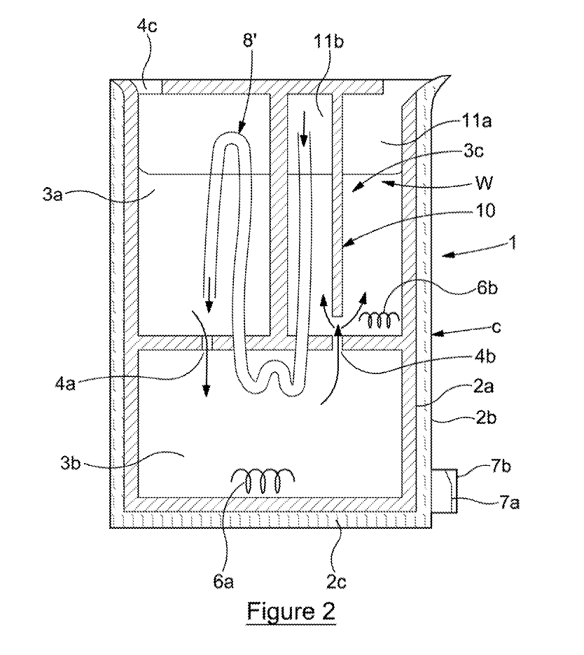

Referring to FIG. 2, this shows a second embodiment that is like the first in the configuration of the at least three chambers 3a, 3b, 3c. There is a heating coil 6a, 6b in each of the second pre-heating chamber 3b and boiling chamber 3c. It differs from the first embodiment in several respects. Firstly the boiling chamber 3c is partitioned/sub-divided into two volumes/sub-chambers 11a, 11b by a dividing wall 10 so that the water in the partitioned volume/sub-chamber 11a immediately adjacent the heating element 6b of the boiling chamber 3c may be heated and poured out directly via an associated pouring spout 1b to provide a single cup-full of hot water, heating substantially only the required single cup volume. The inlet opening 4e for filling the kettle at the first chamber 3a may accordingly be modified to a non-pouring form, omitting the spout 1a there. The dividing wall 10 of the boiling chamber 3c falls mid-way through the passage 4b so that the water may pass up not only into the volume/sub-chamber 11a surrounding the coil 6a, 6b but also the other volume/sub-chamber 11b of the chamber 3c, which incorporates the steam conduit 8′. A pressure relief valve is suitably provided in the kettle, for example at the sub-chamber 11b of the chamber 3c for safety.

A further major respect in which this embodiment differs is the way in which the steam conduit 8′ is routed from the sub-chamber 11b of third chamber 3c to the first chamber 3a. Rather than being direct as in the first embodiment, here in the second embodiment the steam conduit 8′ passes through the intermediate, second chamber 3b before entering the first chamber 3a. As it passes through the second chamber 3b the steam conduit 8′ serves as a heat exchanger to that chamber 3b, giving up some of its heat to the water in that chamber 3b. The heat delivered to the second chamber 3b is suitably such as to assist the water in that second chamber 3b reaching and/or maintaining its target temperature of around 60° C (preferably just below 56° C., to reduce lime-scale build-up). Indeed, for variants of this or other embodiments the kettle might only have a heating means/coil 6 only in the end chamber/third chamber 3c so that the contents of the second chamber 3b are heated solely by conduction/convection from the end chamber/third chamber 3c by the fluid communication through the passage 4b or via the wall in which that passage is formed or from the operation of the steam conduit 8′ as heat exchanger. As with the first embodiment, the steam conduit 8′ terminates in the first chamber 3a and the steam in the conduit 8′ condenses there to transfer the remaining heat of the steam to the cold water in the first chamber 3a, pre-heating it.

In operation the kettle can be run to heat a single cupful bey selection at switch 7b to energise the heating coil 6b of the third chamber 6b only and by a thermostatic or pressure sensing control in the third chamber 3c sub-chamber 11a sensing that the water is boiling in that sub-chamber. The required single cupful volume in the third chamber 3c sub-chamber 11a will be heated to the required boiling temperature directly and in a short time-span. Otherwise the sequence of operation for boiling larger volumes of water is suitably substantially the same as in the first embodiment, suitably with the selector switch 7b set to energise the heating coil 6a of the intermediate chamber 3b too and/or with the heating time being adjusted upwardly accordingly and not terminated as soon as the water in third chamber 3c boils.

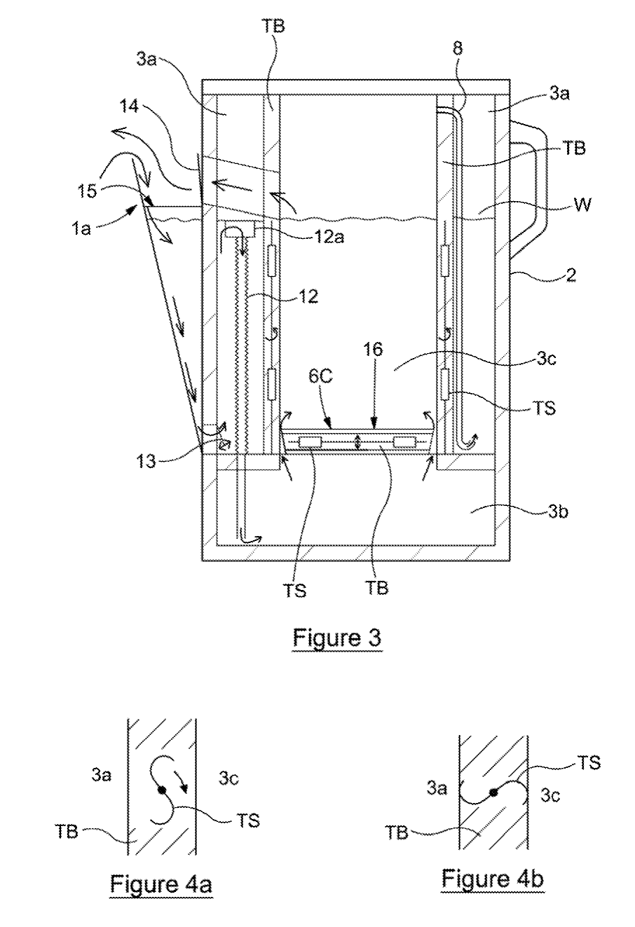

Referring now to FIG. 3, this illustrates a third embodiment of the kettle. Those parts of the kettle in FIG. 3 that correspond to the parts in the preceding figures and embodiments are given corresponding reference numerals.

The third preferred embodiment of the kettle shown in FIG. 3 is a kettle that controls liquid and heat transfers between its three staged heating chambers 3a, 3b, 3c for the various phases of its operation. Heat is recovered both from the steam of the boiling chamber 3c and by direct thermal conduction from the boiling chamber 3c or heating element 6b of the boiling chamber 3c. This kettle, and indeed those of the preceding embodiments too, is particularly preferably an intelligent appliance with the ability to manage its operation in response to sensory feedback, remote control ode or programming and with wide-ranging benefits for the user, for the power supply company and for the whole community by reducing power demand spikes.

The kettle in FIG. 3 is well-insulated. It has an outer casing 2 formed of thermal insulating materials or of a thermally insulating composite construction and may have the construction of a vacuum flask. Substantially the only route for heat to escape from the kettle is thus via the spout 1a at the front upper end of the kettle outer shell.

The spout 1a in the preferred implementation of this embodiment serves as the point for loading fresh water into the kettle as well as for dispensing the boiled water. The spout 1a is suitably substantially sealed closed by a closure valve or cap after re-filling the kettle. Suitably a spring-loaded closure valve 14 is provided at or proximate the outlet of the spout 1a or the outlet 12 of the boiling chamber 1c to the spout 1a. A further one-way valve or barrier 15 in the spout can stop or limit boiling water from partial pouring from passing back down the spout 1a.

As with the previous two embodiments, the third embodiment has three chambers. The first chamber is the first pre-heating chamber 3a that is in valve-controlled fluid communication with the spout 1a where the tap-water is introduced. The first pre-heating chamber 3a in this case is a circular cylindrical annulus and wraps around the boiling chamber 3c as a sleeve. The second pre-heating chamber 3b, as in the previous two embodiments, is at the base of the kettle. In this case the second pre-heating chamber 3b does not have an electrical heating element 6a but instead is adapted to selectively receive heat from the boiling chamber 3c, or rather from the floor of the boiling chamber 3c.

The floor of the boiling chamber 3c incorporates the electrical heating element/boiling plate 6c of the boiling chamber 3c. When the boiled content of the kettle has been poured out of the kettle the electrical heating element/boiling plate 60 and floor and sidewalls of the boiling chamber 3c remain hot for a while as they gradually cool by conduction, convection and radiation. The present invention cleverly operates to recover the residual energy in the boiling chamber floor and sidewalls and the electrical heating element/boiling plate 8c by transferring that heat to the second pre-heating chamber 3b.

The boiling chamber 3c and second pre-heating chamber 3b are insulated from each other by the wall between them. That is to say that the floor of the boiling chamber 3c, or rather the part of it below the boiling plate 6c, forms a thermal barrier TB between the boiling chamber 3c and second pre-heating chamber 3. It substantially prevents thermal transfer from the boiling chamber floor/electrical heating element/boiling plate 6c while the boiling chamber is operating to boil the water therein. However, a switchable thermal shunt TS through the thermal barrier TB is caused to operate when the boiling chamber 3c of the kettle has been emptied out and this places the boiling chamber 3c and second pre-heating chamber 3 in a heat transfer state where the residual heat of the boiling chamber 3c of the kettle is able to pass to the second pre-heating chamber 3. An equivalent thermal barrier TB wall and switchable thermal shunt TS arrangement is provided between the sidewall of the boiling chamber 3c and the first pre-heating chamber 3a, albeit with lesser heat being transferred since the sidewalls of the boiling chamber 3c hold less heat than the floor incorporating the boiling plate 6c.

The first pre-heat chamber 3a surrounds the boiling chamber 3c as an annular sleeve and covers the top of the second pre-heat chamber 3b where the latter is of broader diameter than the boiling chamber 3c. The first pre-heat chamber thus is positioned for its liquid content to absorb the bulk of any waste energy leaking from the boiling chamber 3c through the latter's sidewall or from the top of the second pre-heat chamber 3b. The first pre-heat chamber 3a also receives vapour/steam and condensate from the boiling chamber 3c that collects in the headspace of the boiling chamber 3c. The vapour/steam and condensate is ducted by conduit 8 out of the boiling chamber 3c into the first pre-heat chamber 3a, suitably delivering it to the bottom/near the floor of the first pre-heat chamber 3a.

Turning to the water flows into and through the kettle again, a simple opposing one way valve 13 ensures the correct flow of water from the bottom of the spout 1a into the first pre-heat chamber 3a. The incoming cold water runs into the bottom of the first pre-heating chamber 3a and as it is warmed by the scavenged heat the warmer water will rise and flow from an outlet in the top of chamber 3a. The outlet for the warmed water comprises a flexible outlet tube 12 supported by a float 12a that accommodates for the changing water level in the pre-heat chamber 3a. Water passing down the outlet tube 12 is delivered to near the floor of the second pre-heating chamber 3b. Gravity is used to move the water to pre-heating chamber 3b and to flow through all chambers. As with all of the other embodiments, no pumping is required in the kettle at all.

In the second pre-heating chamber 3b the water is warmed further by the heat scavenged from the floor of the boiling chamber 3c and especially the boiling plate 6c in the floor of the boding chamber 3c. This elevates the temperature of the water further commonly by tens of degrees nearer towards boiling point, but unlike the previous two embodiments of the kettle there is no requirement for a heating element 6b in the second pre-heating chamber 3b when the heat scavenged from the boiling plate 6c in the floor of the boiling chamber 3c is able to perform the role and thus conserve energy. The second pre-heating chamber 3b is another insulated volume and preferably it is a vacuum flask or has one or more vacuum chambers defining its walls, floor and ceiling. It sits below the heating element/boiling plate 6c of the boiling chamber 3c. The water in the second pre-heating chamber 3b is able to store the thermal energy from the boiling chamber 3c that would otherwise go to waste.

The ceiling of the second pre-heating chamber 3b at its central region below the boiling chamber 3c is capped/divided from the boiling chamber 3c by a selectively floating thermally insulated wall or ‘lid’ 16 that suitably is formed with a vacuum flask/vacuum chamber wall construction for optimal thermal barrier between the chambers 3b, 3c. The vacuum flask/vacuum chamber wall construction preferably has an aluminium or steel outer wall accommodating a partial vacuum therewithin. The lower half of the wall/lid 16 is a part of the ceiling of the second pre-heating chamber 3b while the upper half of the wall/lid 16 is the floor of the boiling chamber 3c and incorporates the heating element/boiling plate 6c for boiling the water. The boiling plate 6c suitably comprises an electric heating element contacting a copper flat plate disc.

As touched upon earlier, there is a thermal shunt TS within the vacuum flask of the thermally insulated wall or ‘lid’ 16 that will bridge the thermal barrier defined by the vacuum flask/vacuum chamber wall when triggered to do so once the heating element has switched off. Then the thermal shunt TS will be moved into position to conduct the residual heat of the boiling plate 6c to a lower copper flat plate on the lower face of the wall/lid 16 that is the ceiling of the second pre-heating chamber 3b. The thermal shunt TS is exemplified in FIGS. 4A and 4B as a rotating crank like device with the thermal conductive material formed as wings on a spindle that as the spindle rotates through 90 degrees can be moved from an inoperative position where there is no contact with the aluminium sidewall of the vacuum chamber wall (see FIG. 4A) to a position where the wall on each side of the vacuum chamber is touched by a respective wing of the thermal shunt TS so that heat can flow therethrough right across the thermal barrier defined by the vacuum chamber (see FIG. 4B). A wing of the thermal shunt TS in the lid 16 is suitably when extended to its operative state able or almost able to contact the underside of the boiling plate 6c.

When at rest under gravity the thermal shunt TS does not make contact with either side of the vacuum chamber in which it resides. Powered mechanically, electrically or using a magnet the spindle will rotate the wings into position so it makes contact with both sides of the vacuum chamber thereby enabling heat to be transmitted through the vacuum flask/chamber. The thermal shunt TS is switched on as soon as the kettle has boiled and switched off when the maximum heat transfer is achieved from boiling chamber 3c into the second pre-heat chamber 3b.

Valves form a flow and thermal barrier between the pre-heat first and second chambers 3a, 3b and (as ‘lid’ 16) between the preheat second chamber 3b and boiling chamber 3c. These are be triggered to open when water is poured into the first chamber 3a using a weight (of the water) activated triggering device. This allows the water to flow through the chambers 3a-c and to fill the boiling chamber 3c to the required level. Chamber 3c can have a substantially conventional flat plate heating element to boil the pre-heated water. The boiling chamber 3c is sealed to ensure that the steam from boiling of the water in the boiling chamber 3c passes through the tube 8 from chamber 3c into the first pre-heat chamber 3a. The ‘lid’ 16 moves up and down with water pressure to allow the water to flow from chamber 2 to chamber 3. It is however locked into place until the water is poured in, which will trigger a mechanism that will release it.

The transfer shunts TS in the side walls of the inner vacuum flask, like those of lid 16, also swivel into place to transfer heat to the first pre-heating chamber once the kettle has boiled.

A boiling water outlet near the top of the kettle through the inner and outer vacuum flask walls of the boiling chamber and first pre-heat chamber leads to the pouring exit with its spring loaded valve 14. As soon as the kettle boils the spring loaded valve 14 exiting to the spout 1a will open allowing the boiling chamber 3c to open and the boiling water to be poured normally. This valve 14 will need to be manually or automatically shut after pouring. The boiling chamber 3c as noted previously suitably has a metal twin layer wall which thermally isolates it from chamber 3a. As soon as the kettle boils the thermal transfer shunts TS bridge the thermal barrier provided by that wall.

It is important that the boiling chamber 3c is isolated from the pre-heat chambers 3a and 3b whilst it is boiling to prevent inefficiencies from the thermal drag. The surrounding water filled first pre-heat chamber 3a is at a much lower temperature. As soon as the water in the boiling chamber 3c has boiled or as soon as the water has been poured out transfer shunt TS contact can be made because any energy excess is potentially waste energy that needs to be captured end transferred into the other two chambers 3a, 3b. The kettle will be used most efficiently when only the precise amount of water is boiled and it is filled with cold water just before boiling. To ensure that the water in the first pre-heat chamber 3a that has been heated moves into the second pre-heat chamber 3b when the kettle is being filled with cold water a system of horizontal vanes can be provided to evenly distribute the incoming cold water preventing it from mixing with the warm water too much.

In a convenience-enhanced variant of the FIG. 3 embodiment the kettle upper parts comprising the upper part of the outer casing, spout 21a, first pre-heat chamber 1 and the boiling chamber 3 may be modified to be detachable/de-mountable as a unit from the lower, second pre-heat chamber 1 to provide weight saving when the user needs to pick up the kettle for pouring or re-filling it. In such case enhanced/supplementary flow control barriers are provided between the floor of the de-mountable unit that the user can pick up and the base parts/lower pre-heat chamber that are left behind. The first pre-heat chamber 3a and the boiling chamber 3c sit on top of the second pre-heat chamber 3c. There may however be an extension of chamber 1 in the base as well which may comprise a hose type connection to allow water flow between chambers 3a and 3b and between chambers 3b and 3c. There may also be a metal contact to allow the heat to transfer from chamber 3c to the lower chamber 3b. The boiling element may be re-sited to the lower chamber 3b so that the lower chamber 3b will sit on top of a hot plate type boiling element. Retractable covers could protect the hot surfaces of both top and lower hot plates.

An additional aspect to the invention may comprise provision of a battery that will only be charged from an excess solar PV or other intermittent renewable electrical energy source as power supply that will power a small element in the second pre-heat chamber 3b and give it a small boost to keep it above 65 degrees C. for extended periods of time.

In a further variant of the FIG. 3 embodiment the kettle can operate without flow of liquid from the pre-heat chambers to the boiling chamber. Instead the flows from the pre-heating chambers to the boiling chamber may be solely thermal. Here the pre-heating chambers act as heat exchangers with the boiling chamber. Fresh tap water is introduced directly into the boiling chamber, not via the pre-heating chambers. It is poured into the boiling chamber 3c via an upper opening. The pre-heating chambers 3a and 3b simply store thermal energy as a closed system and heat the boiling chamber by conductive heat transfer through the wall between the chambers when required. As soon as the water temperature in the boiling chamber 3c equalises with the temperature in the pre-heat chambers 3a and 3b the thermal shunt TS can disengage. In the context of the claims hereinafter, the term ‘pre-heat chamber’ includes a chamber that stores pre-heated liquid and transfers heat therefrom through a wall to the boiling liquid before or during heating of the liquid by the boiling plate in the boiling chamber. The thermal shunt TS can be engaged with the boiling plate as soon as the boiling chamber 3c is filled or when required. In this embodiment and in all embodiments the pre-heat chambers provide capacity for thermal energy storage and to maximise that it is preferable in this embodiment and potentially in all embodiments to limit flows of fluid and/or thermal energy to the boiling chamber until actually required.

The kettle as described and illustrated with reference to FIG. 3 can boil in quicker than half the time of a conventional kettle and with a halving or better on energy usage. The kettle also substantially eliminates steam emissions and greatly reduces noise when it boils. The body of the kettle is externally comparatively cool to touch and comparatively safe for even toddlers to touch. Indeed, the whole design of the kettle incorporates safety features that render it substantially spill proof if it falls over.

The kettle, and most especially the smart form of the kettle, can assist with power demand management. The kettle has the ability to store hot water and be pre-heated ahead of need. The kettle can be a smart connected appliance and can form part of a smart local or national electricity power supply net-work/grid. Boiling times can be staggered in response to central control, feedback or through programming to reduce local or national electricity grid overload. When excess energy is generated from local Photo-Voltaic (PV) arrays or other local renewable electrical energy sources the kettle can pre-heat and act as an energy store so that even if there is no means of storing or using the electrical energy elsewhere it may be saved.

As a smart appliance the kettle can be remotely but manually controlled to switch on from a smart phone, tablet or computer. Such devices via an app can also be used to programme the kettle to preheat/boil at opportune moments such as when a TV programme break is approaching or when the home-owner is close to arriving home, getting up in the morning etc. Inputs can be sourced from a TV box, GPS location device, car Sat-Nav, computer internet use, an alarm clock, an Outlook diary, a burglar alarm, PV solar panels, local weather station, national weather forecast or even a national smart grid central control for optimum efficiency.

Artificial intelligence can also be used to predict and learn when the kettle is likely to be used and therefore preheat/boil. This could be based on a programme that takes inputs from the above sources and learns a daily routine and will understand when it varies from the use of other gadgets and location. The accuracy will improve over time as it learns from the actual use compared to predicted use. This will result in the water being pre heated to reduce boiling time when it required for use and to phase the pre-heating switch on time to coincide with excess energy sources (such as PV panels) or to reduce the number of appliances switched on at precisely the same time nationally known as the kettle effect.

Amongst the different levels of smart control that the kettle may afford are: remote manual control; timed & programmed control; reacting to an input from another device when programmed (such as a signal from an alarm clock or signal from disabling of a burglar alarm); reacting to an input from another device automatically; Artificial Intelligence having a processor programmed with one or more predictive algorithms to predict likely or suitable switch on times: and external control to pre-heat therefore phasing kettle switch on times (as part of national grid demand management.

From the fore-going description and the illustrations it will be appreciated that the kettle of the present invention has exceptionally high efficiency, reducing its energy use for boiling and it effectively stores energy. In doing so, it also helps to flatten spikes in energy demand that are energetically costly to the electricity provider (whether the provider is a local or national grid or a small-scale local renewable energy source of intermittent type such as a PV array or wind turbine). The benefits in flattening spikes in energy demand are further enhanced by making the kettle into a smart appliance with micro-processor control that can, predictively or in response to feed-back, stagger boiling times to mitigate against spiking. The kettle can have connectivity to other gadgets such as smart phone and TV along with intelligent learning functions allows for its full integration into a smart connected home.

The design of the kettle enables waste energy to be captured, stored and re-used minimizing power demand spikes, reducing boiling time, reducing energy use and carbon emissions. Further efficiencies can be gained by linking to renewable energy devices in view of the kettle's ability to serve as a store of thermal energy. Despite all of these considerable advancements the kettle is simple to use just like a normal kettle. The user simply needs to pour tap water in and when boiled pour out the boiling water.

1-34. (canceled)

35. A kettle that has a portable container body that may be picked up by a handle and tilted to pour out the heated liquid content with a top opening and spout for pouring, wherein the container has a plurality of chambers comprising:
at least a boiling chamber having a heating element to boil liquid therewithin and connected to at or near the spout for pouring the liquid from the boiling chamber out of the kettle; and
a pre-heat chamber for pre-heating liquid prior to liquid being boiled in the boiling chamber, the kettle having a heat transfer feature to transfer thermal energy from the boiling chamber and/or a boiling plate to the pre-heat chamber for recovering and storing thermal energy in the pre-heat chamber.

36. The kettle as claimed in claim 35, wherein the heat transfer feature for transferring thermal energy from the boiling chamber to the pre-heat chamber comprises a conduit for vapour or condensate from the boiling chamber to the pre-heating chamber.

37. The kettle as claimed in claim 35, wherein the pre-heat chamber is thermally insulated and substantially shielded by a thermal barrier from conductive direct heat transfer relationship with the boiling chamber at least during boiling in the boiling chamber.

38. The kettle as claimed in claim 37, wherein the thermal barrier comprises a vacuum flask/chamber.

39. The kettle as claimed in claim 35, wherein the kettle has a flow control barrier between the pre-heat chamber of the kettle and the boding chamber whereby liquid in the pre-heat chamber of the kettle is allowed to flow to the boiling chamber prior to the boiling chamber being operated to boil the liquid but not while the boiling chamber is operated to boil the liquid.

40. The kettle as claimed in claim 38, wherein the control barrier operatively locked shut but opens when the kettle is to be or being filled.

41. The kettle as claimed in claim 35, wherein, for transferring thermal energy from the boiling chamber to the pre-heat chamber the kettle comprises a heat conductive material thermal shunt.

42. The kettle as claimed in claim 41, wherein the heat conductive material thermal shunt is within a vacuum flask/vacuum chamber between the boiling chamber and the pre-heat chamber and selectively operates to thermally bypass a thermal barrier defined by the vacuum flask/vacuum chamber.

43. The kettle as claimed in claim 41, wherein the heat conductive material thermal shunt is configured to selectively be moved into and out of a position that thermally bridges to the pre-heat chamber.

44. The kettle as claimed in claim 41, wherein the heat conductive material thermal shunt is automated or controlled by a controller to flip/switch from an inoperative state where it does not bridge to the pre-heat chamber to an operative state where it does bridge to the pre-heat chamber.

45. The kettle as claimed in claim 44, wherein the heat conductive material thermal shunt is automated to switch to the operative state once the liquid in the kettle boiling chamber has been poured out.

46. The kettle as claimed in claim 35, wherein the heating of the liquid loaded into the kettle is carried out in stages, each stage elevating the temperature of the liquid farther and being in a successive one of the chambers.

47. The kettle as claimed in claim 35, wherein the kettle has a first pre-heat chamber as an upper chamber and a second pre-heat chamber as a lower chamber, below the first pre-heat chamber.

48. The kettle as claimed in claim 35, wherein the kettle insulation of the casing and/or thermal barrier where present comprises a cellular or foam lining and/or there is an air gap or partial vacuum between the casing and the chambers.

49. The kettle as claimed in claim 35, wherein the kettle has one or more valves/controlled closure means to shut apertures/conduits between the first and second chambers and the second and third chambers.

50. The kettle as claimed in claim 49, wherein the kettle is configured to close the passages between adjoining chambers, isolating them from each other when the kettle is switched on to allow dwell time for the liquid in the respective chambers to be heated sufficiently before passing to the next chamber.

51. The kettle as claimed in claim 47, wherein the first pre-heat chamber and the boiling chamber are detachable as a unit from the lower second pre-heat chamber to provide weight saving when the user needs to pick up the kettle for pouring or re-filling.

52. The kettle as claimed in claim 35, wherein a pre-heat chamber surrounds the boiling chamber as an annulus.

53. The kettle as claimed in claim 35, wherein a pre-heating chamber adjoins a sidewall of the boiling chamber and has a thermal barrier wall between it and the boiling chamber that has a selectively operable thermal shunt, whereby residual heat from the boiling chamber sidewall may be conductively transferred to the pre-heating chamber.

54. The kettle that has a portable container body that may be picked up by a handle and tilted to pour out the heated liquid content with a top opening and spout for pouring, wherein the container has a boiling chamber having a heating element to boil liquid therewithin, wherein the kettle is insulated and adapted to store thermal energy, and wherein the kettle has a processor or controller that is programmed to control the kettle to manage operation of the kettle's use of energy, wherein the processor or controller is programmed with one or more predictive algorithms to predict and thence control the kettle to manage operation of the kettle's use of energy and minimize demand spikes or enable the kettle to be pre-heated or boiled for predicted demand.
